(19) United States
(12) Patent Application Publication
(10) Pub. No.: US 2017/0177956 A1
(43) Pub. Date: Jun. 22, 2017

(54) DETECTION APPARATUS AND METHOD FOR PARKING SPACE, AND IMAGE PROCESSING DEVICE

(71) Applicant: FUJITSU LIMITED, Kawasaki (JP)

(72) Inventor: Cong ZHANG, Beijing (CN)

(73) Assignee: FUJITSU LIMITED, Kawasaki (JP)

(21) Appl. No.: 15/380,045

(22) Filed: Dec. 15, 2016

(30) Foreign Application Priority Data
Dec. 18, 2015 (CN) 201510957305.6

(51) Int. Cl. G06K 9/00

(52) U.S. Cl. CPC G06K 9/00812; G06K 9/00805

(57) ABSTRACT

A detection apparatus and method for parking space detection and an image processing device where the detection method includes: performing conversion on a side-view image that is photographed on the parking space and is acquired from a camera, to obtain a top-view image including said parking space; acquiring an edge image including a plurality of edges based on gradient information of said top-view image; performing conversion on said edge image and obtains a voting vector according to said gradient information, and determining marking lines according to peak values of said voting vector; and determining one or more parking spaces based on a plurality of said marking lines.

### CROSS-REFERENCE TO RELATED APPLICATIONS

This application claims the priority benefit of Chinese Patent Application No. 201510957305.6, filed on Dec. 18, 2015 in the Chinese Intellectual Property Office, the disclosure of which is incorporated herein in its entirety by reference.

### BACKGROUND

1. Field

The embodiments of the present disclosure relate to the technical field of image processing, in particular to a detection apparatus and method for parking space and an image processing device.

2. Description of the Related Art

Currently, more and more electronic apparatuses are applied in vehicles to provide comfort and safety of driving. Due to the existence of blind spots behind a vehicle, cannot observe directly, thus for a driver (especially a green hand or inexperienced driver), parking is a difficult and complex task. Consequently, there have been various parking assisting apparatuses designed into modern vehicles to assist parking.

For example, an ultrasonic system is a parking assisting apparatus that is widely used. An ultrasonic sensor installed at a bumper at the tail of a vehicle transmits a pulse signal, then the pulse signal is reflected back by a barrier, such that a distance can be measured between the vehicle and the barrier. But the ultrasonic system cannot provide information such as position or shape of the barrier, and furthermore cannot detect information of a parking space identified on the bottom surface.

With the development and popularization of a digital image sensor, digital cameras are increasingly used in the parking assisting apparatuses. The camera installed at the tail portion of the vehicle can provide real-time video behind the vehicle, therefore blind spots behind the vehicle are not unviewable any longer for a driver, thereby being able to better provide the driver with assisting information.

Note that the above introduction to the background of the disclosure is stated only for the convenience of clear and complete explanation to the technical solution of the present disclosure, and for the convenience of understanding of persons skilled in the art. It should not be regarded that the above technical solutions are publicly known to persons skilled in the art just because that these solutions are explained in the Background part of the present disclosure.

### SUMMARY

Additional aspects and/or advantages will be set forth in part in the description which follows and, in part, will be apparent from the description, or may be learned by practice of the embodiments.

However, the inventor finds that in the existing parking assisting systems, since what is provided by the camera is a side-view image, a driver cannot visually and accurately observe distance and position of a parking space due to the perspective effect, and the detected parking space information is not accurate enough.

The embodiments of the present disclosure provide a detection apparatus and method for parking space and an image processing device. It is expected to be able to visually and accurately observe distance and position of a parking space, and to be able to detect the parking space information more accurately.

According to a first aspect of the embodiments of the present disclosure, there is provided with a detection apparatus for parking space, the detecting apparatus including:
an angle conversion unit configured to perform conversion on a side-view image that is photographed on the parking space and is acquired from a camera, to obtain a top-view image comprising said parking space;
an edge acquisition unit configured to acquire an edge image comprising a plurality of edges based on gradient information of said top-view image;
a marking line determination unit configured to perform conversion on said edge image and obtain a voting vector according to said gradient information, and determine marking lines according to peak values of said voting vector; and
a parking space determination unit configured to determine one or more parking spaces based on a plurality of said marking lines.

According to a second aspect of the embodiments of the present disclosure, there is provided with a detection method for parking space, the detection method including:
performing conversion on a side-view image that is photographed on the parking space and is acquired from a camera, to obtain a top-view image comprising said parking space;
acquiring an edge image comprising a plurality of edges based on gradient information of said top-view image;
performing conversion on said edge image and obtains a voting vector according to said gradient information, and determining marking lines according to peak values of said voting vector; and
determining one or more parking spaces based on a plurality of said marking lines.

According to a third aspect of the embodiments of the present disclosure, there is provided with an image processing device including the detection apparatus for parking space as described above.

The embodiments of the present disclosure achieve the following beneficial effects: performing conversion on a side-view image that is photographed on the parking space and is acquired from a camera to obtain a top-view image; acquiring an edge image based on gradient information of the top-view image, and determining marking lines according to peak values of said voting vector. Thereby, it is able not only to visually and accurately observe distance and position of a parking space, but also to automatically detect the parking space, and accuracy of detection is higher.

With reference to the aftermentioned description and drawings, a specific embodiment of the disclosure is disclosed in detail, which specifies principle of the disclosure and modes in which the disclosure can be adopted. It should be understood that the embodiment of the disclosure is not limited in the scope. The embodiment of the disclosure can include many variations, modifications and equivalents within the scope of the appended claims and provisions.

Features described and/or shown for one embodiment can be used in other one or more embodiments in the same or a similar manner, can be combined with features in other embodiments, or replace features in other embodiments.

It should be emphasized that the term “comprise/include” means existence of a feature, an assembly, a step or components when used herein, but is not exclusive of existence or addition of one or more other features, assembly, steps or components.

### BRIEF DESCRIPTION OF THE DRAWINGS

The included accompanying drawings are used for providing further understanding to the embodiment of the present disclosure and constitute a part of the Description, for illustrating the embodiments of the present disclosure and interpreting principle of the present disclosure together with verbal description. Obviously, the accompanying figures in the following description are merely some embodiments of the disclosure, and it is practicable for those skilled in the art to obtain other accompanying figures according to these ones in the premise of making no creative efforts. In the drawings:

FIG. 1 is a schematic of a detection method for parking space according to the first embodiment of the present disclosure;

FIG. 2 is an exemplary diagram of a side-view image according to the first embodiment of the present disclosure;

FIG. 3 is a schematic of parameters used in conversion according to the first embodiment of the present disclosure;

FIG. 4 is an exemplary diagram of a top-view image according to the first embodiment of the present disclosure;

FIG. 5 is a schematic of acquiring an edge image according to the first embodiment of the present disclosure;

FIG. 6 is a schematic of an edge image according to the first embodiment of the present disclosure;

FIG. 7 is an exemplary diagram of peak values of a voting vector according to the first embodiment of the present disclosure;

FIG. 8 is an exemplary diagram of marking lines according to the first embodiment of the present disclosure;

FIG. 9 is an exemplary diagram of a parking space according to the first embodiment of the present disclosure;

FIG. 10 is another schematic of a detection method for parking space according to the first embodiment of the present disclosure;

FIG. 11 is another exemplary diagram of a parking space according to the first embodiment of the present disclosure;

FIG. 12 is a schematic of a detection apparatus for parking space according to a second embodiment of the present disclosure;

FIG. 13 is another schematic of a detection apparatus for parking space according to the second embodiment of the present disclosure;

FIG. 14 is a schematic of an edge acquisition unit according to the second embodiment of the present disclosure;

FIG. 15 is a structural schematic of an image processing device according to a third embodiment of the present disclosure.

### DETAILED DESCRIPTION

Reference will now be made in detail to the embodiments, examples of which are illustrated in the accompanying drawings, wherein like reference numerals refer to the like elements throughout. The embodiments are described below by referring to the figures.

The aforementioned and other features of the embodiments of the disclosure will become apparent from the following description with reference to the accompanying drawings. In the description and its accompanying drawings, specific embodiments of the disclosure are disclosed, which specifies part of the embodiments in which principle of the examples of the disclosure can be adopted. It should be understood that, the present disclosure is not limited to the described embodiments, but on the contrary, the examples of the present disclosure includes all modifications, variations and equivalents that fall within the scope of the appended claims.

### The First Embodiment

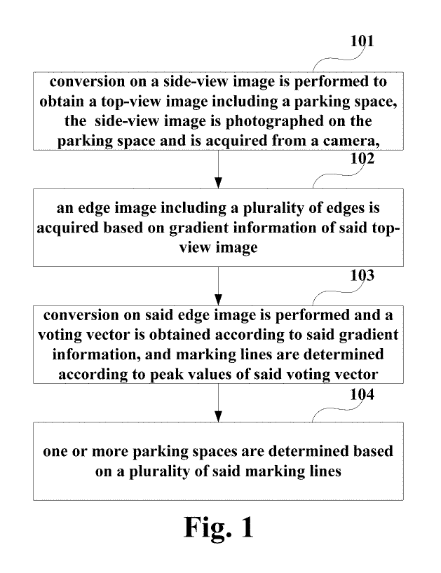

The embodiment of the present disclosure provides a detection method for parking space, for automatically detecting the parking space by processing an image acquired by a camera. FIG. 1 is a schematic of a detection method for parking space according to the embodiment of the present disclosure, as shown in FIG. 1, the detection method includes:
a step 101 of performing conversion on a side-view image that is photographed on the parking space and is acquired from a camera, to obtain a top-view image including said parking space;
a step 102 of acquiring an edge image including a plurality of edges based on gradient information of said top-view image;
a step 103 of performing conversion on said edge image and obtains a voting vector according to said gradient information, and determining marking lines according to peak values of said voting vector; and
a step 104 of determining one or more parking spaces based on a plurality of said marking lines.

In this embodiment, a camera can be provided at a rear part of a vehicle, for example at a bumper, to acquire video of circumstance behind the vehicle. But the present disclosure is not limited to this, the camera can also be provided at any position of the vehicle according to the need. Through the video took by the camera, a side-view image (also referred to as a rear view image, represented by Iᵣₑₐᵣ) of a parking space can be acquired.

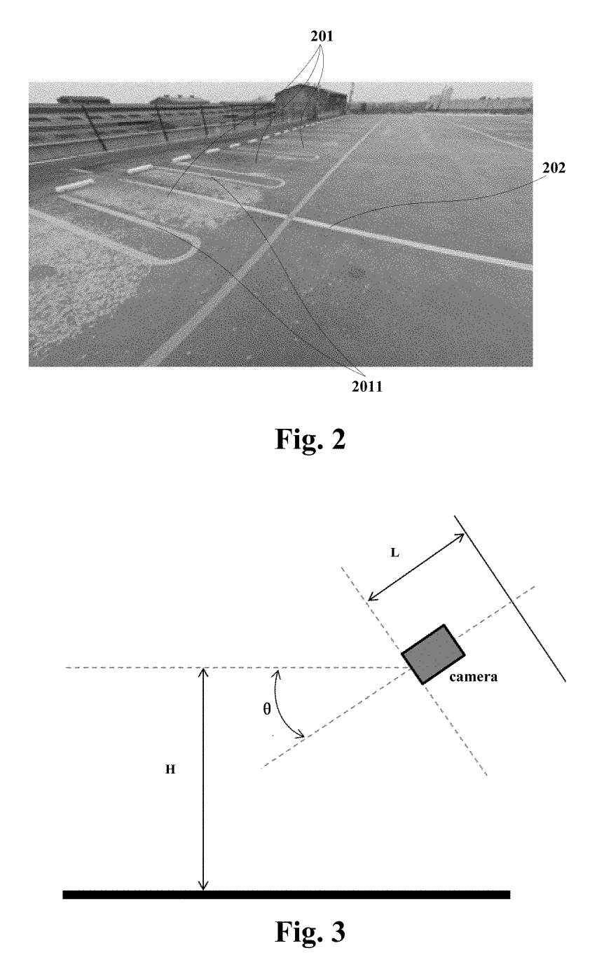

FIG. 2 is an exemplary diagram of a side-view image according to the embodiment of the present disclosure. As shown in FIG. 2, the side-view image may include one or more parking spaces 201, each parking space 201 includes two parking marking lines 2011. Moreover, as shown in FIG. 2, the side-view image may also include other marking lines, for example non-parking marking lines 202 and so on.

In the step 101, it is able to perform conversion on the side-view image to obtain a top-view image (also referred to as a bird-view image, represented by I_{bird}) including a parking space. For example, it is able to convert the side-view image into the top-view image based on parameters of the camera; said parameters may include the following information: a focal length L of said camera, an included angle θ between said camera and a horizontal plane, and a height H of said camera from the ground. But the present disclosure is not limited to this, and for example other parameters can also be used for performing conversion.

FIG. 3 is a schematic of parameters used in conversion according to the embodiment of the present disclosure. Through these physical parameters of the camera, a conversion matrix can be obtained, and then the side-view image is converted into the top-view image according to the conversion matrix. Specific details of such conversion can be known with reference to related technologies of image angle conversion.

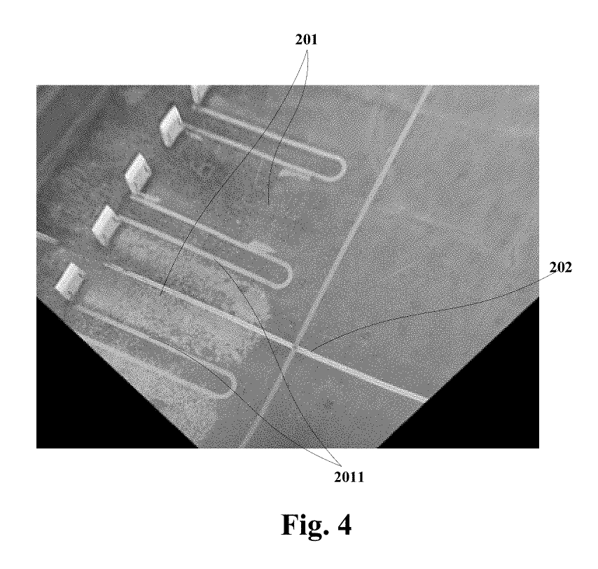

FIG. 4 is an exemplary diagram of a top-view image according to the embodiment of the present disclosure, showing a top-view image obtained after an angle conversion on the side-view image in FIG. 2. As shown in FIG. 4, the perspective effect can be eliminated through the top-view image, and a driver can visually and accurately observe the parking space.

In the step 102, it is possible to acquire an edge image including a plurality of edges based on gradient information of said top-view image.

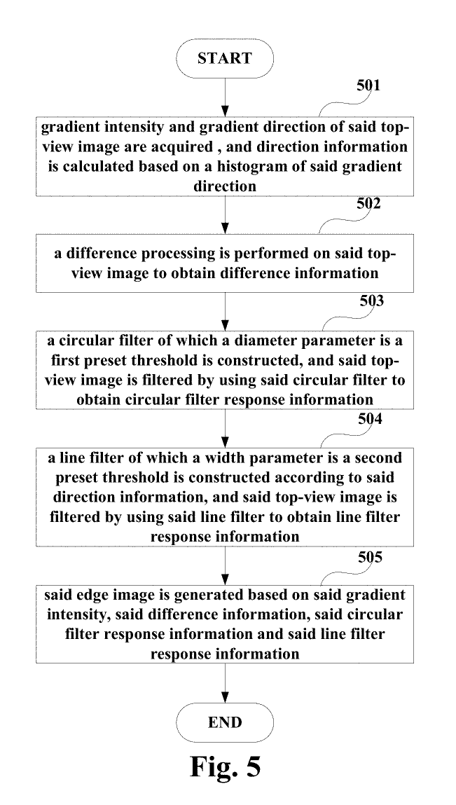

FIG. 5 is a schematic of acquiring an edge image according to the embodiment of the present disclosure, as shown in FIG. 5, the process of acquiring the edge image may include:
A step 501 of acquiring gradient intensity and gradient direction of said top-view image, and calculating direction information based on a histogram of said gradient direction;
in this embodiment, for example a canny edge detector may be used, and a Harris operator can be utilized to respectively obtain gradient intensity Gs and gradient direction Gd of I_{bird}; then a histogram hist_{Gd} of the gradient direction can be calculated, thereby obtaining direction information dir of the parking marking lines.
A step 502 of performing a difference processing on said top-view image to obtain difference information;
in this embodiment, it is also possible to perform image difference processing, for example, it is possible to perform subtraction operation on pixel values in a certain region in the I_{bird} to obtain the difference information Diff. The objects on which difference is performed can be determined according to the demand, for example it is possible to perform difference processing on two pixels in the gradient direction.
A step 503 of constructing a circular filter of which a diameter parameter is a first preset threshold, and filtering said top-view image by using said circular filter to obtain circular filter response information;
in this embodiment, a diameter parameter d_{circ} of a circular filter h_{circ} is a first preset threshold value;
for example, d_{circ}=widthₗᵢₙₑ, this widthₗᵢₙₑ may be width of a typical parking marking line, and can be determined using an experience value in advance. Thereby circular filter response information, for example, can be expressed as:

R_{circ}=I_{bird}*h_{circ}.
A step 504 of constructing a line filter of which a width parameter is a second preset threshold according to said direction information, and filtering said top-view image by using said line filter to obtain line filter response information;
in this embodiment, a width parameter wₗᵢₙₑ of the line filter hₗᵢₙₑ is the second preset threshold;
for example, wₗᵢₙₑ=widthₗᵢₙₑ, this widthₗᵢₙₑ may be width of a typical parking marking line, and can be determined using an experience value in advance. Thereby line filter response information, for example, can be expressed as:

Rₗᵢₙₑ=I_{bird}*hₗᵢₙₑ.
A step 505 of generating said edge image based on said gradient intensity, said difference information, said circular filter response information and said line filter response information.

In this embodiment, pixels in said edge image may be generated according to the following formula:

$$if \{ \begin{matrix}Diff ( i , j ) > {threshold}_{diff} \\ Gs ( i , j ) > Gs ( {i}_{prev} , {j}_{prev} ) \\ Gs ( i , j ) > Gs ( {i}_{next} , {j}_{next} ) , then Edge ( i , j ) = 1 , else Edge ( i , j ) = 0 \\ {R}_{circ} ( i , j ) > {threshold}_{R} \\ {R}_{line} ( i , j ) > {threshold}_{R}\end{matrix}$$

where, (i, j) denotes a pixel to be generated; Diff () denotes said difference information, threshold_{diff} is a third preset threshold; Gs() denotes said gradient intensity; (iₚᵣₑᵥ, jₚᵣₑᵥ), (iₙₑₓₜ, jₙₑₓₜ) are two adjacent pixels of said pixels (i, j) in said gradient direction; R_{circ} and Rₗᵢₙₑ respectively denote said circular filter response information and said line filter response information, threshold_{R} is a fourth preset threshold.

That is, if the above condition is satisfied, then the pixel value Edge (i, j) of the pixel (i, j) in the edge image is 1, otherwise the pixel value Edge (i, j) is 0. Thereby a binarization image including a plurality of edges can be obtained. It is worth noting that, FIG. 5 only schematically shows the circumstance of the present disclosure that the edge image is acquired, but the present disclosure is not limited to this. For example, sequence of the steps can also be adjusted according to the actual situation, or one or several steps thereamong can be added or reduced.

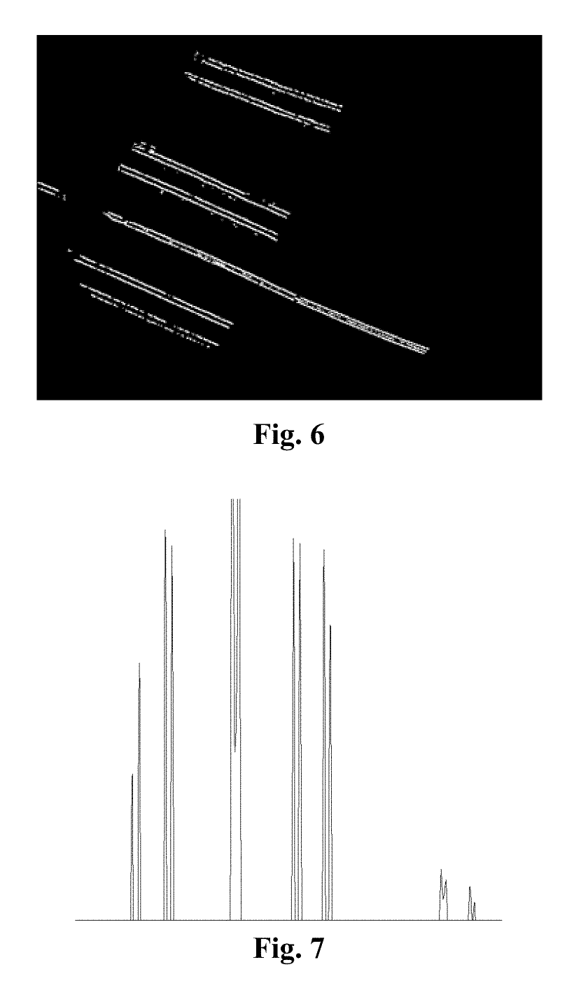

FIG. 6 is a schematic of an edge image according to the embodiment of the present disclosure, showing the circumstance that an edge image is obtained from the side-view image in FIG. 4. As shown in FIG. 6, a certain amount of noise can be eliminated to accurately obtain a plurality of stable edges.

In the step 103, it is possible to perform conversion on said edge image and obtains a voting vector according to said gradient information, and to determine marking lines according to peak values of said voting vector.

For example, it is possible to perform Hough conversion on the edge image and obtain a voting vector Arr_{Hough} (r, θ) of parameter space; r represents a distance and represents an angle. For the pixel (i, j), if Edge (i, j) is 1, then

Arr_{Hough}(r=i cos θ+j sin θ,θ)plus 1, θ=1°,2°,3° . . . 180°;

Based on the direction information dir obtained in the step 501, a one-dimensional voting vector will be obtained:

vec_{Hough}(r)=Arr_{Hough}(r,θ=dir).

In this voting vector vec_{Hough}(r), each peak value indicates a marking line in the previously obtained direction dir in the edge image Edge; thereby the marking line can be determined according to the peak value in the voting vector; moreover, such method of determining the marking line according to the peak value of the voting vector can better remove interferences, and can further improve accuracy of detection.

FIG. 7 is an exemplary diagram of peak values of a voting vector according to the embodiment of the present disclosure, showing the circumstance that the marking line is determined according to the peak values of the voting vector. As shown in FIG. 7, a position where the peak value occurs can be determined as the position of the marking line.

Furthermore, it is also possible to further determine two edges of the marking line according to a fifth preset threshold; said fifth preset threshold includes a threshold (a sixth threshold) of distance between the two edges of the marking line, and/or gradient direction of the two edges of the marking line.

For example, each marking line has two edges, if the distance between two edges is equal to or approximately equal to the width of a typical marking line (for example the line width is 10 cm), and the two edges has opposite gradient directions, then it can be determined that the two edges are edges of some marking line, so as to extract the marking line.

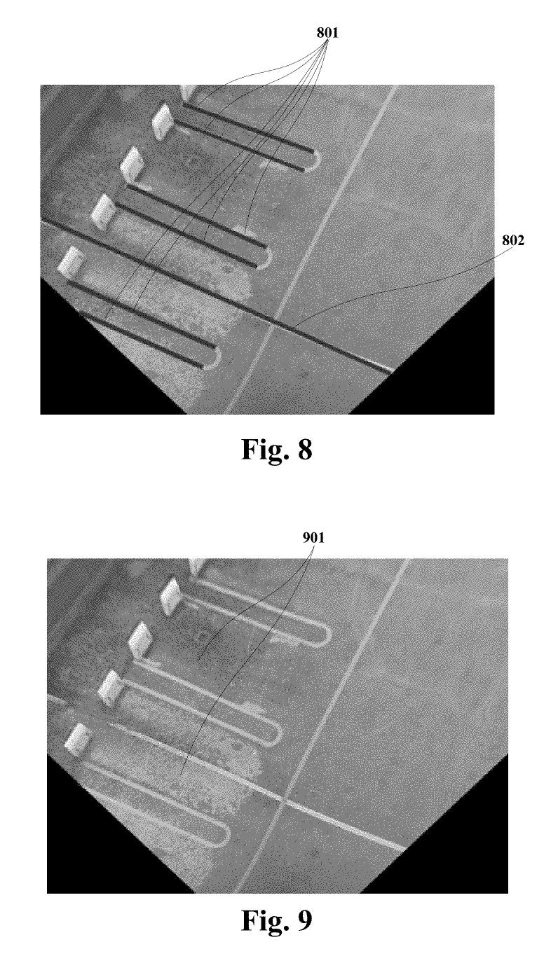

FIG. 8 is an exemplary diagram of marking lines according to the embodiment of the present disclosure, showing the circumstance that the extracted marking line is superimposed on the top-view image. As shown in FIG. 8, for example seven marking lines (including six parking marking lines 801 and one non-parking marking line 802) can be extracted according to the step 103, each marking line having two edges.

In the step 104, it is possible to determine one or more parking spaces based on a plurality of said marking lines. It is possible to determine two parking marking lines of a certain or particular parking space from a plurality of said marking lines according to a sixth preset threshold; and determine a region formed by said two parking marking line as a parking space.

Said sixth preset threshold may include one of following information or any combination thereof: a threshold of distance between two parking marking lines of a parking space (for example 3 m), a threshold of a length difference between parking marking lines of a parking space (for example 10 cm) and a threshold of a color difference between parking marking lines of a parking space (for example RGB value is 10). But the present disclosure is not limited to this, and for example the parking space can also be determined according to other parameters.

For example, if the distance between two marking lines is about 3 m, the length difference between the two does not exceed 10 cm, the difference between RGB values of the two does not exceed 10, then it can be determined that the region between the two marking lines conforms to the feature of a typical parking space.

FIG. 9 is an exemplary diagram of a parking space according to the embodiment of the present disclosure, showing the circumstance of parking spaces determined according to the marking lines in FIG. 8. As shown in FIG. 9, two parking spaces 901 can be automatically detected.

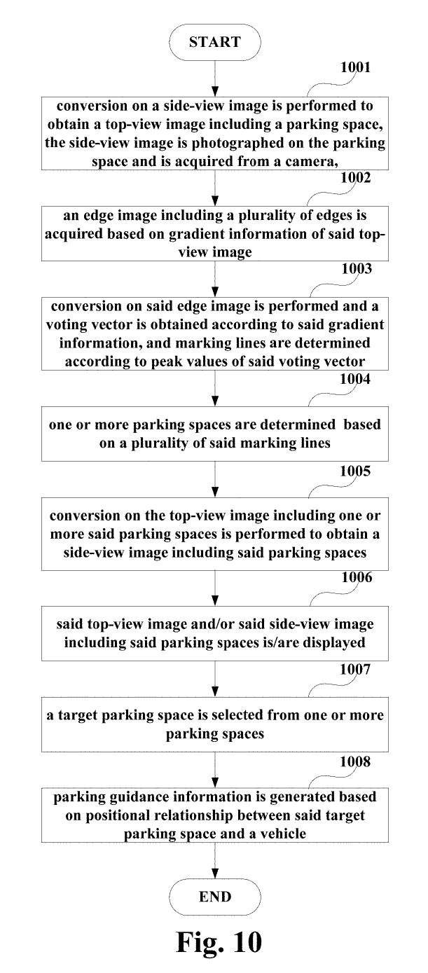

FIG. 10 is another schematic of a detection method for parking space according to the embodiment of the present disclosure. As shown in FIG. 10, the detection method includes:
a step 1001 of performing conversion on a side-view image that is photographed on the parking space and is acquired from a camera, to obtain a top-view image including said parking space;
a step 1002 of acquiring an edge image including a plurality of edges based on gradient information of said top-view image;
a step 1003 of performing conversion on said edge image and obtains a voting vector according to said gradient information, and determining marking lines according to peak values of said voting vector; and
a step 1004 of determining one or more parking spaces based on a plurality of said marking lines.

As shown in FIG. 10, the detection method may further include:
a step 1005 of performing conversion on the top-view image including one or more said parking spaces to obtain a side-view image including said parking spaces; and
a step 1006 of displaying said top-view image and/or said side-view image including said parking spaces.

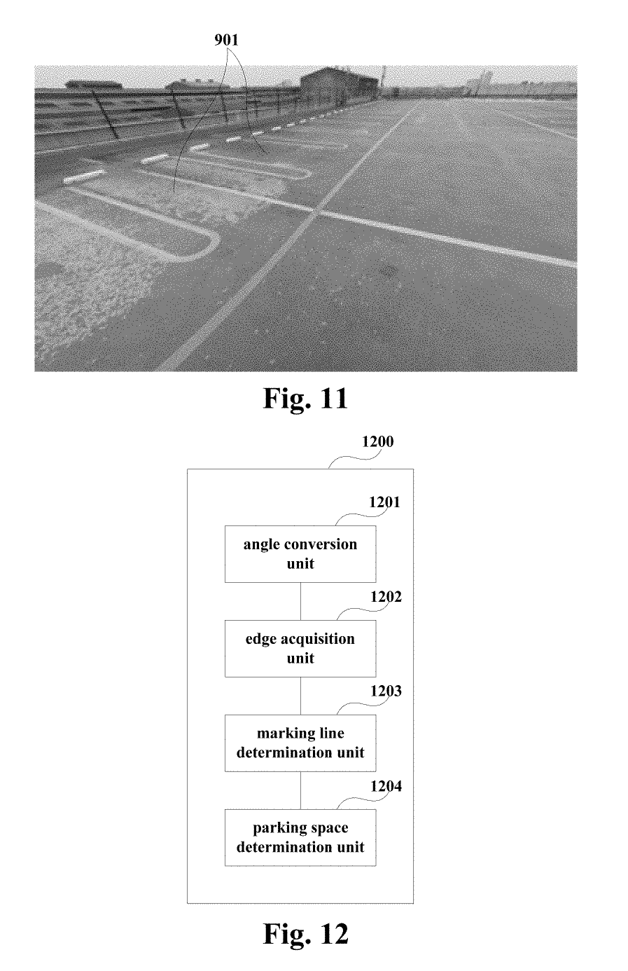

FIG. 11 is another exemplary diagram of a parking space according to the embodiment of the present disclosure, showing the circumstance after the top-view image shown in FIG. 9 is converted into a side-view image. Thereby, the driver can observe the automatically detected parking space from multiple perspectives, and can observe distance and position of the parking space more visually and accurately.

As shown in FIG. 10, the detection method may further include:
a step 1007 of selecting a target parking space from the one or more parking spaces; and
a step 1008 of generating parking guidance information based on positional relationship between said target parking space and a vehicle.

In this embodiment, it is possible to automatically select a target parking space (for example the parking space closest to the vehicle), and it is also possible for the driver to manually select a target parking space and input corresponding information. Furthermore, it is possible to generate parking guidance information based on positional relationship between the target parking space and the vehicle, for example, alarm information for prompting the distance between the target parking space and the vehicle, and so on. Thereby after the parking space is detected automatically, parking guidance information can be better provided.

It can be seen from the above embodiment that: performing conversion on a side-view image that is photographed on the parking space and is acquired from a camera to obtain a top-view image; acquiring an edge image based on gradient information of the top-view image, and determining marking lines according to peak values of said voting vector. Thereby, it is able not only to visually and accurately observe distance and position of a parking space, but also to automatically detect the parking space, and accuracy of detection is higher.

### The Second Embodiment

The embodiment of the present disclosure provides a detection apparatus for parking space, and contents the same as that of the first embodiment will not be repeated.

FIG. 12 is a schematic of a detection apparatus for parking space according to the embodiment of the present disclosure, as shown in FIG. 12, a detection apparatus 1200 for parking space includes:
an angle conversion unit 1201 configured to perform conversion on a side-view image that is photographed on the parking space and is acquired from a camera, to obtain a top-view image including said parking space;
an edge acquisition unit 1202 configured to acquire an edge image including a plurality of edges based on gradient information of the top-view image;
a marking line determination unit 1203 configured to perform conversion on said edge image and obtain a voting vector according to said gradient information, and determine marking lines according to peak values of said voting vector; and
a parking space determination unit 1204 configured to determine one or more parking spaces based on a plurality of said marking lines.

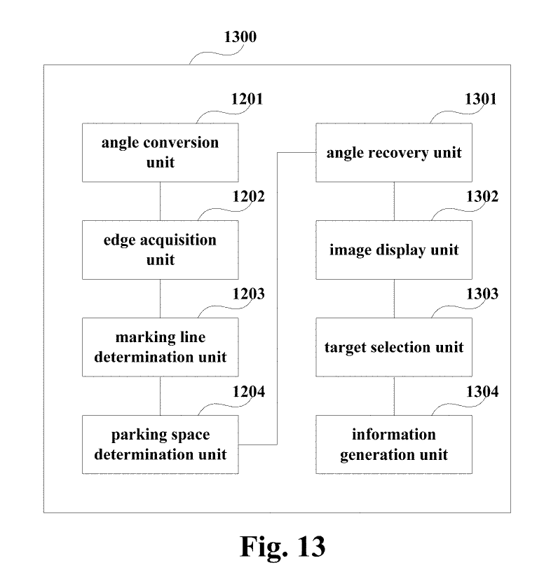

FIG. 13 is another schematic of a detection apparatus for parking space according to the embodiment of the present disclosure. As shown in FIG. 13, a detection apparatus 1300 for parking space includes: the angle conversion unit 1201, the edge acquisition unit 1202, the marking line determination unit 1203 and the parking space determination unit 1204, as described above.

As shown in FIG. 13, the detection apparatus 1300 of the parking space may further include:
an angle recovery unit 1301 configured to perform conversion on the top-view image including one or more said parking spaces to obtain a side-view image including said parking spaces; and
an image display unit 1302 configured to display said top-view image and/or said side-view image including said parking spaces.

As shown in FIG. 13, the detection apparatus 1300 of the parking space may further include:
a target selection unit 1303 configured to select a target parking space from one or more parking spaces; and
an information generation unit 1304 configured to generate parking guidance information based on positional relationship between the target parking space and a vehicle.

In this embodiment, said angle conversion unit 1201 may be configured to convert said side-view image into said top-view image based on parameters of said camera; said parameters includes a focal length of said camera, an included angle between said camera and a horizontal plane, and a height of said camera from the ground.

Said marking line determination unit 1203 may also be used for further determining two edges of said marking line according to a fifth preset threshold; said fifth preset threshold may include a threshold of distance between the two edges of the marking line and/or gradient direction of the two edges of the marking line; but the present disclosure is not limited to this.

Said parking space determination unit 1204 may also be used for determining two parking marking lines of a certain or particular parking space from a plurality of said marking lines according to a sixth preset threshold; and determining a region formed by said two parking marking line as said parking space;
said sixth preset threshold may include one of following information or any combination thereof: a threshold of distance between two parking marking lines of a parking space, a threshold of a length difference between parking marking lines of a parking space and a threshold of a color difference between parking marking lines of a parking space; but the present disclosure is not limited to this.

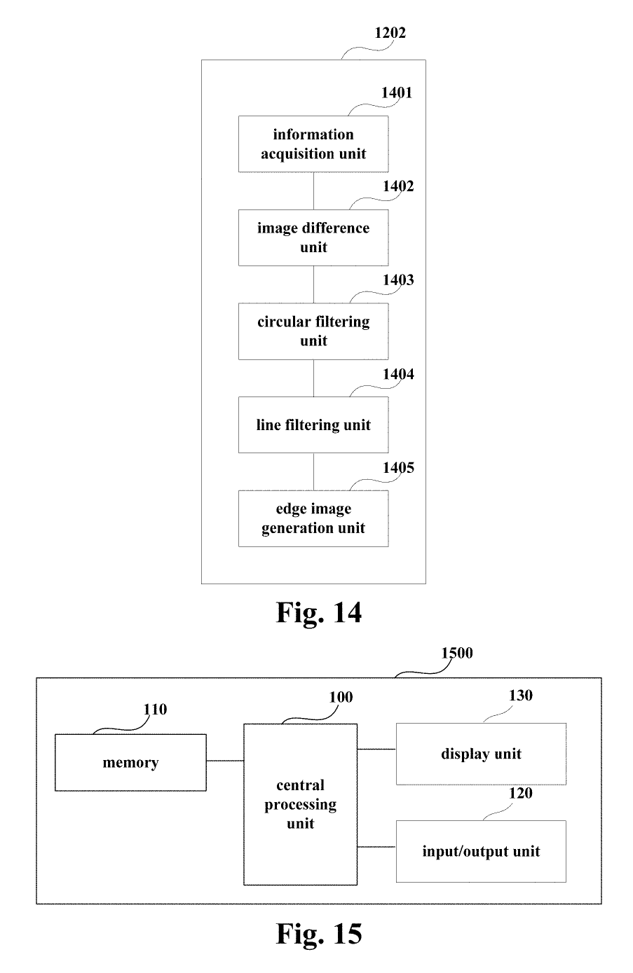

FIG. 14 is a schematic of an edge acquisition unit according to the embodiment of the present disclosure. As shown in FIG. 14, said edge acquisition unit 1202 may include:
an information acquisition unit 1401 configured to acquire gradient intensity and gradient direction of said top-view image, and calculate direction information based on a histogram of said gradient direction;
an image difference unit 1402 configured to perform a difference processing on said top-view image to obtain difference information;
a circular filtering unit 1403 configured to construct a circular filter of which a diameter parameter is a first preset threshold, and filter said top-view image by using said circular filter to obtain circular filter response information;
a line filtering unit 1404 configured to construct a line filter of which a width parameter is a second preset threshold according to said direction information, and filter said top-view image by using said line filter to obtain line filter response information;
an edge image generation unit 1405 configured to generate said edge image based on said gradient intensity, said difference information, said circular filter response information and said line filter response information.

The edge image generation unit 1405 may be configured to generate pixels in said edge image according to the following formula:

$$if \{ \begin{matrix}Diff ( i , j ) > {threshold}_{diff} \\ Gs ( i , j ) > Gs ( {i}_{prev} , {j}_{prev} ) \\ Gs ( i , j ) > Gs ( {i}_{next} , {j}_{next} ) , then Edge ( i , j ) = 1 , else Edge ( i , j ) = 0 \\ {R}_{circ} ( i , j ) > {threshold}_{R} \\ {R}_{line} ( i , j ) > {threshold}_{R}\end{matrix}$$

where, (i, j) denotes a pixel to be generated; Diff () denotes said difference information, threshold_{diff} is a third preset threshold; Gs () denotes said gradient intensity; (iₚᵣₑᵥ, jₚᵣₑᵥ), (iₙₑₓₜ, jₙₑₓₜ) are two adjacent pixels of said pixels (i, j) in said gradient direction; R_{circ} and Rₗᵢₙₑ respectively denote said circular filter response information and said line filter response information, threshold_{R} is a fourth preset threshold.

It can be seen from the above embodiment that: performing conversion in side-view image that is a photograph of the parking space and is acquired from a camera to obtain a top-view image; acquiring an edge image based on gradient information of the top-view image, and determining marking lines according to peak values of said voting vector. Thereby, it is able not only to visually and accurately observe distance and position of a parking space, but also to automatically detect the parking space, and accuracy of detection is higher.

### The Third Embodiment

The embodiment of the present disclosure provides an image processing device, including: the detection apparatus for parking space according to the second embodiment.

FIG. 15 is a structural schematic of an image processing device according to the embodiment of the present disclosure. As shown in FIG. 15, the image processing device 1500 may include: a central processing unit (CPU) and a memory 110; the memory 110 is coupled to the central processing unit 100. The memory 110 can store various data, also store program for information processing, and execute the program under the control of the central processing unit 100.

In one embodiment, the function of the detection apparatus 1200 or 1300 of the parking space can be integrated into the central processing unit 100. The central processing unit 100 can be configured to realize the detection method for parking space according to the first embodiment.

In another embodiment, the detection apparatus 1200 or 1300 of the parking space can be configured separately from the central processing unit, for example, the detection apparatus 1200 or 1300 of the parking space can be configured as a chip/chips connected to the central processing unit 100, and the function of the detection apparatus 1200 or 1300 of the parking space can be realized through control of the central processing unit 100.

Furthermore, as shown in FIG. 15, the image processing device 1500 may further include: an input/output unit 120 and a display unit 130, etc.; functions of the above components are similar to those in the prior art, and thus will not be repeated. It is worth noting that, it is not necessary for the image processing device 1500 to include all components shown in FIG. 15; in addition, the image processing device 1500 may further include components not shown in FIG. 15, with reference to the prior art.

The embodiment of the present disclosure further provides a computer-readable program, when the program is executed in the image processing device, the program enables the image processing device to carry out the detection method for parking space according to the first embodiment.

The embodiment of the present disclosure further provides a non-transitory computer readable storage medium in which a computer-readable program or method is stored, wherein the computer-readable program or method enables an image processing device to carry out the detection method for parking space according to the first embodiment.

The above devices and methods of the disclosure can be implemented by hardware, or by combination of hardware with software. The disclosure relates to such a computer readable program that when the program is executed by a logic component, it is possible for the logic component to implement the preceding devices or constitute components, or to realize the preceding various methods or steps. The disclosure further relates to a non-transitory computer readable storage medium for storing the above programs or methods, such as a hard disk, a magnetic disk, an optical disk, a DVD, a flash memory and the like.

Hereinbefore the disclosure is described by combining specific embodiments, but those skilled in the art should understand, these descriptions are exemplary and are not limitation to the protection scope of the disclosure. Those skilled in the art can make various variations and modifications to the disclosure according to principle of the disclosure, and these variations and modifications shall fall within the scope of the disclosure.

Regarding the embodiment including the above examples, there is further provided with the following appendix:

(Appendix 1). A detection apparatus for parking space, including:

an angle conversion unit configured to perform conversion on a side-view image that is photographed on the parking space and is acquired from a camera, to obtain a top-view image comprising said parking space;
an edge acquisition unit configured to acquire an edge image comprising a plurality of edges based on gradient information of said top-view image;
a marking line determination unit configured to perform conversion on said edge image and obtain a voting vector according to said gradient information, and determine marking lines according to peak values of said voting vector; and
a parking space determination unit configured to determine one or more parking spaces based on a plurality of said marking lines.

(Appendix 2). The detection apparatus according to the appendix 1, wherein the detection apparatus further includes:

an angle recovery unit configured to perform conversion on the top-view image comprising one or more said parking spaces to obtain a side-view image comprising said parking spaces; and
an image display unit configured to display a side-view image comprising said parking spaces.

(Appendix 3). The detection apparatus according to the appendix 1, wherein the detection apparatus further includes:

a target selection unit configured to select a target parking space from one or more said parking spaces; and
an information generation unit configured to generate parking guidance information based on positional relationship between said target parking space and a vehicle.

(Appendix 4). The detection apparatus according to the appendix 1, wherein said angle conversion unit is configured to convert said side-view image into said top-view image based on parameters of said camera; wherein said parameters includes a focal length of said camera, an included angle between said camera and a horizontal plane, and a height of said camera from the ground.

(Appendix 5). The detection apparatus according to the appendix 1, wherein said edge acquisition unit includes:

an information acquisition unit configured to acquire gradient intensity and gradient direction of said top-view image, and calculate direction information based on a histogram of said gradient direction;
an image difference unit configured to perform a difference processing on said top-view image to obtain difference information;
a circular filtering unit configured to construct a circular filter of which a diameter parameter is a first preset threshold, and filter said top-view image by using said circular filter to obtain circular filter response information;
a line filtering unit configured to construct a line filter of which a width parameter is a second preset threshold according to said direction information, and filter said top-view image by using said line filter to obtain line filter response information;
an edge image generation unit configured to generate said edge image based on said gradient intensity, said difference information, said circular filter response information and said line filter response information.

(Appendix 6). The detection apparatus according to the appendix 5, wherein said edge image generation unit is configured to generate pixels in said edge image according to the following formula:

$$if \{ \begin{matrix}Diff ( i , j ) > {threshold}_{diff} \\ Gs ( i , j ) > Gs ( {i}_{prev} , {j}_{prev} ) \\ Gs ( i , j ) > Gs ( {i}_{next} , {j}_{next} ) , then Edge ( i , j ) = 1 , else Edge ( i , j ) = 0 \\ {R}_{circ} ( i , j ) > {threshold}_{R} \\ {R}_{line} ( i , j ) > {threshold}_{R}\end{matrix}$$

where, (i, j) denotes a pixel to be generated; Diff () denotes said difference information, threshold_{diff} is a third preset threshold; Gs () denotes said gradient intensity; (iₚᵣₑᵥ, jₚᵣₑᵥ), (iₙₑₓₜ, jₙₑₓₜ) are two adjacent pixels of said pixels (i, j) in said gradient direction; R_{circ} and Rₗᵢₙₑ respectively denote said circular filter response information and said line filter response information, threshold_{R} is a fourth preset threshold.

(Appendix 7). The detection apparatus according to the appendix 1, wherein said marking line determination unit is further configured to determine two edges of said marking line according to a fifth preset threshold;

(Appendix 8). The detection apparatus according to the appendix 7, wherein said fifth preset threshold comprises a threshold of distance between the two edges of the marking line and/or gradient direction of the two edges of the marking line.

(Appendix 9). The detection apparatus according to the appendix 1, wherein said parking space determination unit is further configured to determine two parking marking lines of a certain parking space from a plurality of said marking lines according to a sixth preset threshold; and determine a region formed by said two parking marking line as said parking space.

(Appendix 10). The detection apparatus according to the appendix 9, wherein said sixth preset threshold comprises one of following information or any combination thereof: a threshold of distance between two parking marking lines of a parking space, a threshold of a length difference between parking marking lines of a parking space and a threshold of a color difference between parking marking lines of a parking space.

(Appendix 11). A detection method for parking space, including:

performing conversion on a side-view image that is photographed on the parking space and is acquired from a camera, to obtain a top-view image comprising said parking space;
acquiring an edge image comprising a plurality of edges based on gradient information of said top-view image;
performing conversion on said edge image and obtains a voting vector according to said gradient information, and determining marking lines according to peak values of said voting vector; and
determining one or more parking spaces based on a plurality of said marking lines.

(Appendix 12). The detection method according to the appendix 11, wherein the detection method further includes:

performing conversion on the top-view image comprising one or more said parking spaces to obtain a side-view image comprising said parking spaces; and
displaying a side-view image comprising said parking spaces.

(Appendix 13). The detection method according to the appendix 11, wherein the detection method further includes:

selecting a target parking space from one or more said parking spaces; and
generating parking guidance information based on positional relationship between said target parking space and a vehicle.

(Appendix 14). The detection method according to the appendix 11, wherein, converting said side-view image into said top-view image based on a parameter of said camera; wherein said parameter includes a focal length of said camera, an included angle between said camera and a horizontal plane, and a height of said camera from the ground.

(Appendix 15). The detection method according to the appendix 11, wherein, acquiring an edge image comprising a plurality of edges based on gradient information of said top-view image includes:

acquiring gradient intensity and gradient direction of said top-view image, and calculating direction information based on a histogram of said gradient direction;
performing a difference processing on said top-view image to obtain difference information;
constructing a circular filter of which a diameter parameter is a first preset threshold, and filtering said top-view image by using said circular filter to obtain circular filter response information;
constructing a line filter of which a width parameter is a second preset threshold according to said direction information, and filtering said top-view image by using said line filter to obtain line filter response information;
generating said edge image based on said gradient intensity, said difference information, said circular filter response information and said line filter response information.

(Appendix 16). The detection method according to the appendix 15, wherein pixels in said edge image are generated according to the following formula:

$$if \{ \begin{matrix}Diff ( i , j ) > {threshold}_{diff} \\ Gs ( i , j ) > Gs ( {i}_{prev} , {j}_{prev} ) \\ Gs ( i , j ) > Gs ( {i}_{next} , {j}_{next} ) , then Edge ( i , j ) = 1 , else Edge ( i , j ) = 0 \\ {R}_{circ} ( i , j ) > {threshold}_{R} \\ {R}_{line} ( i , j ) > {threshold}_{R}\end{matrix}$$

wherein, (i, j) denotes a pixel to be generated; Diff () denotes said difference information, threshold_{diff} is a third preset threshold; Gs () denotes said gradient intensity; (iₚᵣₑᵥ, jₚᵣₑᵥ), (iₙₑₓₜ, jₙₑₓₜ) are two adjacent pixels of said pixels (i, j) in said gradient direction; R_{circ} and Rₗᵢₙₑ respectively denote said circular filter response information and said line filter response information, threshold_{R} is a fourth preset threshold.

(Appendix 17). The detection method according to the appendix 11, wherein, further determining two edges of said marking line according to a fifth preset threshold;

said fifth preset threshold comprises a threshold of distance between the two edges of the marking line and/or gradient direction of the two edges of the marking line.

(Appendix 18). The detection method according to the appendix 11, wherein, determining two parking marking lines of a certain parking space from a plurality of said marking lines according to a sixth preset threshold; and determining a region formed by said two parking marking line as said parking space;

said sixth preset threshold comprises one of following information or any combination thereof: a threshold of distance between two parking marking lines of a parking space, a threshold of a length difference between parking marking lines of a parking space and a threshold of a color difference between parking marking lines of a parking space.

(Appendix 19). An image processing device including the detection apparatus for parking space according to any one of the appendix 1 to appendix 10.

Although a few embodiments have been shown and described, it would be appreciated by those skilled in the art that changes may be made in these embodiments without departing from the principles and spirit of the embodiments, the scope of which is defined in the claims and their equivalents.

What is claimed is:

1. A detection apparatus for a parking space, comprising:
an angle conversion unit configured to perform conversion of a side-view image a photograph of the parking space acquired via a camera, to obtain a top-view image of said parking space;
an edge acquisition unit configured to acquire an edge image comprising a plurality of edges based on gradient information of said top-view image;
a marking line determination unit configured to perform conversion of said edge image and obtain a voting vector according to said gradient information, and determine marking lines according to peak values of said voting vector; and
a parking space determination unit configured to determine one or more parking spaces based on a plurality of said marking lines.

2. The detection apparatus according to claim 1, wherein the detection apparatus further comprises:
an angle recovery unit configured to perform conversion on the top-view image including one or more of said parking spaces to obtain the side-view image including said parking spaces; and
an image display unit configured to display one of said top-view image and said side-view image comprising said parking spaces.

3. The detection apparatus according to claim 1, wherein the detection apparatus further comprises:
a target selection unit configured to select a target parking space from the one or more said parking spaces; and
an information generation unit configured to generate parking guidance information based on a positional relationship between said target parking space and a vehicle.

4. The detection apparatus according to claim 1, wherein said angle conversion unit is configured to convert said side-view image into said top-view image based on parameters of said camera; wherein said parameters comprise a focal length of said camera, an included angle between said camera and a horizontal plane, and a height of said camera from a ground.

5. The detection apparatus according to claim 1, wherein said edge acquisition unit comprises:
an information acquisition unit configured to acquire a gradient intensity and a gradient direction of said top-view image, and calculate direction information based on a histogram of said gradient direction;
an image difference unit configured to perform difference processing on said top-view image to obtain difference information;
a circular filtering unit configured to construct a circular filter of which a diameter parameter is a first preset threshold, and filter said top-view image by using said circular filter to obtain circular filter response information;
a linear filtering unit configured to construct a linear filter of which a width parameter is a second preset threshold according to said direction information, and filter said top-view image by using said linear filter to obtain linear filter response information;
an edge image generation unit configured to generate said edge image based on said gradient intensity, said difference information, said circular filter response information and said linear filter response information.

6. The detection apparatus according to claim 5, wherein said edge image generation unit is configured to generate pixels in said edge image according to:
$$if \{ \begin{matrix}Diff ( i , j ) > {threshold}_{diff} \\ Gs ( i , j ) > Gs ( {i}_{prev} , {j}_{prev} ) \\ Gs ( i , j ) > Gs ( {i}_{next} , {j}_{next} ) , then Edge ( i , j ) = 1 , else Edge ( i , j ) = 0 \\ {R}_{circ} ( i , j ) > {threshold}_{R} \\ {R}_{line} ( i , j ) > {threshold}_{R}\end{matrix}$$
wherein, (i, j) denotes a pixel to be generated; Diff () denotes said difference information, threshold_{diff} is a third preset threshold; Gs() denotes said gradient intensity; (iₚᵣₑᵥ, jₚᵣₑᵥ), (iₙₑₓₜ, jₙₑₓₜ) are two adjacent pixels of said pixel (i, j) in said gradient direction; R_{circ} and Rₗᵢₙₑ respectively denote said circular filter response information and said linear filter response information, threshold_{R} is a fourth preset threshold.

7. The detection apparatus according to claim 1, wherein said marking line determination unit is further configured to determine two edges of one of said marking lines according to a fifth preset threshold;
wherein said fifth preset threshold comprises a threshold of one of a distance between the two edges of the marking line and gradient direction of the two edges of the marking line.

8. The detection apparatus according to claim 1, wherein said parking space determination unit is further configured to determine two parking marking lines of a particular parking space from a plurality of said marking lines according to a sixth preset threshold; and determine a region formed by said two parking marking lines as said parking space;
wherein said sixth preset threshold comprises one of or a combination of: a threshold of distance between the two parking marking lines of the parking space, a threshold of a length difference between parking marking lines of the parking space and a threshold of a color difference between parking marking lines of the parking space.

9. A detection method for a parking space, comprising:
performing conversion of a side-view image that is a photographof the parking space and is acquired from a camera, to obtain a top-view image comprising said parking space;
acquiring an edge image comprising a plurality of edges based on gradient information of said top-view image;
performing conversion of said edge image and obtaining a voting vector according to said gradient information, and determining marking lines according to peak values of said voting vector; and
determining one or more parking spaces based on a plurality of said marking lines.

10. An image processing device comprising the detection apparatus for parking space according to claim 1.

11. The detection apparatus according to claim 1, wherein the detection apparatus further comprises:
a guidance unit providing parking guidance information for the parking space to a driver.

12. The detection method according to claim 9, further comprising:
providing parking guidance information for the parking space to a driver.

13. A non-transitory computer readable recoding medium storing a detection method for a parking space, the method comprising:
performing conversion on a side-view image that is photographed on the parking space and is acquired from a camera, to obtain a top-view image comprising said parking space;
acquiring an edge image comprising a plurality of edges based on gradient information of said top-view image;
performing conversion on said edge image and obtains a voting vector according to said gradient information, and determining marking lines according to peak values of said voting vector; and
determining one or more parking spaces based on a plurality of said marking lines.

14. A method, comprising:
performing conversion of a side-view image of the parking space into a top-view of image;
determining gradient information of edges of the top view image;
obtaining a voting vector using said gradient information, and determining space marking lines using peak values of said voting vector;
determining the parking space based on said marking lines; and
providing parking guidance information for the parking space to a driver.

15. A non-transitory computer readable recoding medium storing a method, the method comprising:
performing conversion of a side-view image of the parking space into a top-view of image;
determining gradient information of edges of the top view image;
obtaining a voting vector using said gradient information, and determining space marking lines using peak values of said voting vector;
determining the parking space based on said marking lines; and
providing parking guidance information for the parking space to a driver.

16. An apparatus, comprising:
a central processing unit having a processor and a memory, the processor including:
an angle conversion unit configured to perform conversion of a side-view image of the parking space into a top-view of image;
an edge acquisition unit configured to determine gradient information of edges of the top view image;
a marking line determination unit configured to obtain a voting vector using said gradient information, and determining space marking lines using peak values of said voting vector;
a parking space determination unit configured to determine the parking space based on said marking lines; and
a guidance unit configured to provide parking guidance information for the parking space to a driver.

17. A method, comprising:
performing conversion of a side-view image of the parking space into a top-view of image;
determining gradient information of edges of the top view image;
obtaining a voting vector using said gradient information, and determining space marking lines using peak values of said voting vector;
determining the parking space based on said marking lines; and
providing parking guidance information for the parking space to a driver comprising multiple different perspective views of the parking space.

18. The detection method according to claim 17, wherein the multiple different perspective views of the parking space comprise a side view and a top view.

19. The detection method according to claim 17, wherein the multiple different perspective views of the parking space provide distance to and position of the parking space.
